(19) United States
(12) Patent Application Publication
(10) Pub. No.: US 2011/0185636 A1
(43) Pub. Date: Aug. 4, 2011

(54) ENCLOSED POWERED GATE POST

(76) Inventor: Edward J. Stull, Oxford, MI (US)

(21) Appl. No.: 13/011,009

(22) Filed: Jan. 21, 2011

Related U.S. Application Data
(63) Continuation-in-part of application No. 13/055,168, filed on Apr. 26, 2011.
(60) Provisional application No. 61/082,959, filed on Jul. 23, 2008.

(51) Int. Cl. E05F 15/04

(52) U.S. Cl. 49/348

(57) ABSTRACT

A powered post assembly includes an enclosed actuator that supports rotation of a gate. An outer tube defines a hollow interior space. A fixed post and a rotating post are both disposed within the outer tube. The actuator is mounted within the fixed post and drives rotation of the rotating post. Because the actuator is disposed within the fixed tube, it is sheltered from the elements and from undesired tampering.

### CROSS REFERENCE TO RELATED APPLICATIONS

This application is a continuation-in-part of co-pending U.S. application Ser. No. 13/055,168 filed Jan. 21, 2011, which claims priority to PCT Application No. PCT/US2009/051494 filed Jul. 23, 2009, which claims priority to U.S. Provisional Application No. 61/082,959 filed on Jul. 23, 2008.

### BACKGROUND

This disclosure generally relates to an automatic gate opener. More particularly, this disclosure relates to a powered gate post for opening a gate assembly.

An automatic gate typically includes an articulated arm attached to a motor mounted external and apart from a gate. The motor drives the articulated arm to rotate the gate between open and closed positions. The articulated arm is exposed and susceptible to accidental and intentional damage. Accordingly, it is desirable to design and develop an automatic gate opening device that is not susceptible to such damage.

### SUMMARY

A disclosed example powered gate assembly includes a powered post assembly with an enclosed actuator that supports rotation of a gate assembly. The powered post assembly includes an outer tube that defines a hollow interior space. Slots are provided in the outer tube through which extend corresponding threaded rods. The threaded rods provide a mounting location for the gate assembly. The actuator is mounted within a fixed post and moves a rotatable post supported on the fixed post.

The fixed post and the rotating post are both disposed within the oval tube. The actuator mounted within the fixed post drives a drive pin. The drive pin extends through a drive slot in the fixed post and extends into a drive channel within the rotating post. The drive slot includes a shape that translates vertical movement into rotational movement. The rotational movement is translated through the drive pin to the driven channel to rotate the rotating post within the outer post.

Because the actuator is disposed within the fixed post, it is sheltered from the elements and from undesired tampering. The rotating post is supported on the fixed post through a bearing assembly disposed along the axis.

Accordingly, the disclosed example gate assembly includes features that provide for the automatic opening and closing while concealing and protecting the drive mechanism and actuator from the elements or undesired tampering.

### BRIEF DESCRIPTION OF THE DRAWINGS

FIG. 1 is a schematic view of an example powered gate post assembly.

FIG. 2A is a top view of the example powered gate post assembly.

FIG. 2B is an enlarged cross-sectional view of a top portion of the powered gate post assembly.

FIG. 3 is a perspective view of a portion of the example powered gate post assembly.

FIG. 4 is a view of an inner fixed post.

FIG. 5 is a view of an outer rotating post.

FIG. 6 is a schematic view of the interface between the inner fixed post and the outer rotating post.

FIG. 7 is a base and clamp assembly for securing the inner fixed post.

FIG. 8 is an example fastening assembly for securing a gate to the powered gate post.

### DETAILED DESCRIPTION OF THE PREFERRED EMBODIMENT

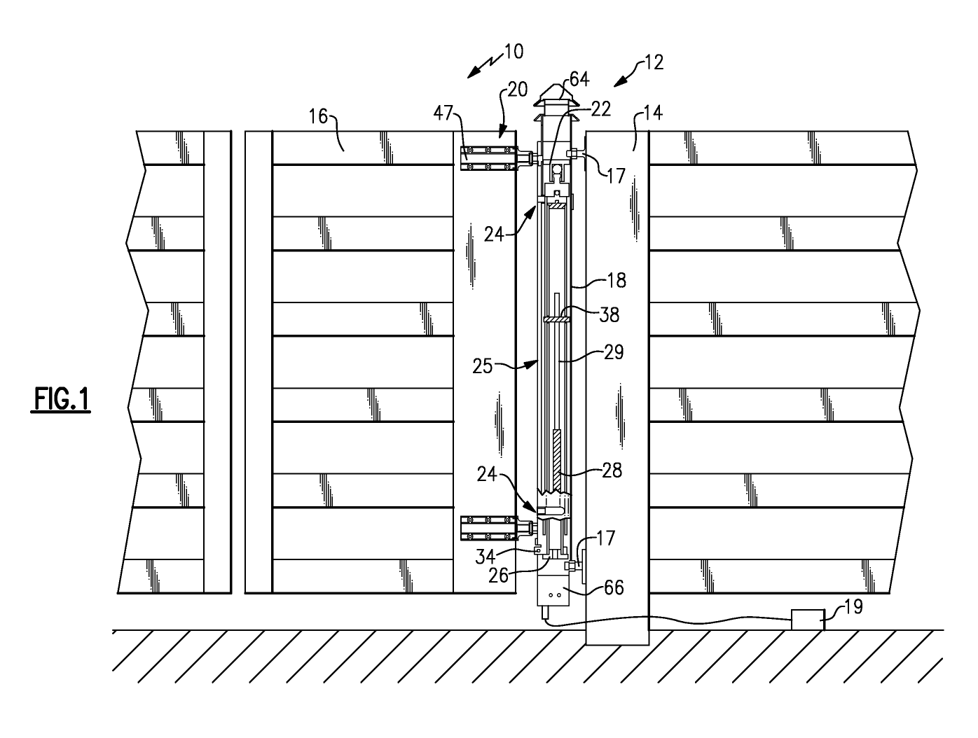

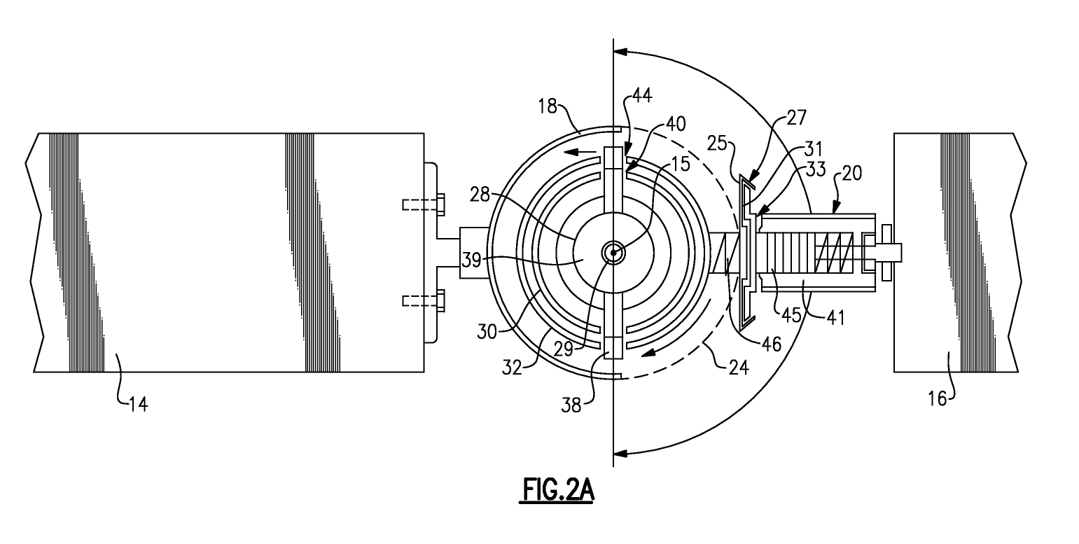

Referring to FIGS. 1, 2A and 2B an example powered gate assembly 10 includes a powered post assembly 12 that supports rotation of a gate assembly 16. The powered post assembly 12 is mounted to a post 14 of a fence 14 by brackets 17. A light 64 is mounted to a top portion of the example powered post assembly 12. An actuator 28 disposed within the powered post assembly 12 is controlled by an controller 66 also mounted within the powered post assembly 12 to provide a single unitary device for facilitating opening and closing of the gate assembly. The powered post assembly 12 can be actuated by a remote wireless transmitter that communicates with the controller 66 or by a wired controller located remotely.

The powered post assembly 12 includes an outer tube 18 to which the brackets 17 are attached. The outer tube 18 defines a hollow interior space 20. Slots 24 are provided in the outer tube 18 through which extend corresponding threaded rods 46. The threaded rods 46 provide for mounting of bracket 25 for movement with a rotating post 32 disposed within the interior space 20 of the outer tube 18. The bracket 25 provides an adjustable mounting location for fastening assemblies 20 that are in turn attached to the gate assembly 16. The threaded rods 46 are moved within the slots 24 about an axis 15 to move the gate assembly 16. The threaded rods 46 are fixed to a rotating post 32. The rotating post 32 is supported on a fixed post 30 within the outer tube 18. An actuator 28 moves the rotatable post 32 through a drive mechanism disposed within the fixed post 30.

The bracket 25 extends a substantial length of the outer tube 18 and includes tabs 27 that define a channel 31. The channel 31 extends the length of the bracket 25. A sliding element 33 is fit within the channel 31 and is movable within the channel 25. A nut 41 is received within the sliding element 33 and is tightened to cause engagement of a threaded member with a surface 45 of the channel 25 and hold the fastening assembly 20 in place. The example fastening assembly 20 includes a holder 47 for attachment directly to the gate assembly 16. The example holder 47 includes openings for threaded members to secure the gate assembly 16. The sliding element 33 is infinitely adjustable along the bracket 25 to facilitate any gate assembly configuration. Moreover, movement of the sliding element provides for a height adjustment of the gate assembly 16.

The fixed post 30 and the rotating post 32 are both disposed within the outer tube 18. The fixed post 30 is rotationally fixed by a clamp 34 supported on a base plate 26. The clamp 34 fixes the rotational position of the fixed post 30 in a desired position so that the gate assembly position is as desired. Adjustment of the gate assembly position can be changed by unclamping the clamp 34, rotating the fixed post 30 to the desired position, and reengaging the clamp 34 to maintain the desired position.

The slots 24 in the outer tube 18 are of such a length about the outer tube 18 such that a desired amount of gate swing or opening angle is provided. In operation, the rotating post 32 moves within the outer tube 18 such that outwardly only the threaded rods 46 and the bracket are observed as moving. The remaining moving parts are hidden within the interior space of the outer tube 18 in the example, the slots 24 provide approximately 180 degrees of gate swing. As appreciated, the size and length of the slots 24 can be tailored to accommodate the desired amount of gate swing. Accordingly, the example gate assembly can be opened in any direction as is provided by the length of the slots 24,

A cap 22 is provided at the top of the outer tube 18 that includes a ball 37 disposed atop a top guide 36 mounted on the rotating post 32. The cap 22 increases structural rigidity of the outer tube 18 and includes a sleeve 35 that receives a guide post 39 of a top guide 36 mounted to the rotating post 32. The ball 37 is disposed between the guide post 37 and the cap 22. The interface between the top guide 36, the ball 37, the guide post 39 and the sleeve 35 of the cap 22 provides a rigid support structure that maintains spacing between the fixed outer tube 18 and the rotating post 32. Maintaining spacing between the outer tube 18 and the rotating post 32 therein maintains the spacing of the threaded rods 46 as they move within the slots 24.

The actuator 28 is mounted within the fixed post 30 and drives a threaded drive shaft 29. A drive pin 38 is attached to a driven member 39 that is in threading engagement with the threaded drive shaft 29. Rotation of the threaded drive shaft 29 generates linear movement of the driven member 39 and thereby the drive pin 38. The drive pin 38 guides within a drive slot 40 of the fixed post 30. The drive slot 40 includes a shape that translates the linear movement of the drive pins 38 into rotational movement. The example drive slot 40 includes an arcuate shape that provides for swinging of the gate assembly 16 in both directions. In other words, the drive slot 40 includes a profile that drives rotation of the gate assembly 16 in a first direction when the drive pin 38 is driven vertically upward and in a second direction opposite from the first direction when the drive pin 38 is driven vertically downward. A middle position moves the gate assembly to a closed or home position. This provides a 180 degree swing opening of the gate assembly 16. The swing of the gate assembly 16 between a closed position and an open position can be tailored to the desired application by modifying the shape and length of the drive slot 40.

The drive pin 38 extends through the drive slot 40 into a driven channel 44 within the rotating post 32. The drive channel 44 is straight such that rotational movement of the drive pin 38 causes rotation of the rotating post 32 relative to both the fixed post 30 and the outer post 18.

The example actuator 28 rotates the drive shaft 29 about the axis 15 causing vertical movement of the driven member 39. The drive slot 40 includes an arcuate shape in the vertical direction that drives rotation of the drive pins 38 about the axis 15. The rotation generated by the drive slot is transferred to the driven channels 44 in the rotating post 32. Although a rotary motor is utilized as the example actuator, other actuators that produce linear movement are also within the contemplation of this invention. An axial position between the rotating post 32 and the fixed support 30 is constant at all times during both operation and rest. In other words, the rotating post 32 remains supported on the fixed support 30. The rotating post 32 is not lifted off axial off the fixed support 30.

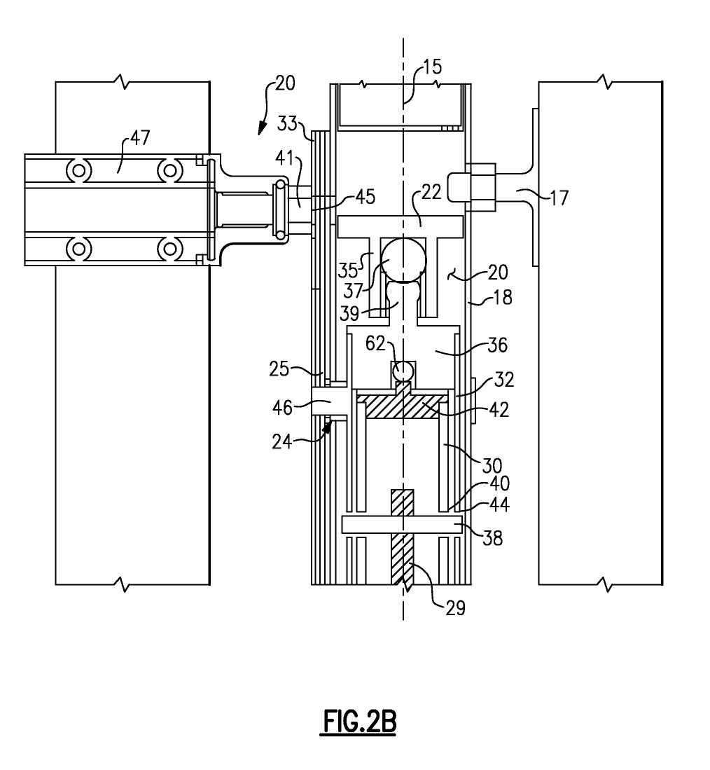

Referring to FIG. 3 with continuing reference to FIGS. 1, 2A and 2B, the actuator 28 is disposed entirely within the fixed tube 30. The rotating post 32 is disposed about and rotates relative to the fixed tube 30. Because the actuator 28 is disposed within the fixed tube 30, it is sheltered from the elements and from undesired tampering. The actuator 28 is an electric motor and receives electric power from an outside power source such as alternating current, or may be powered using a direct current power supply such as a battery 19 shown in FIG. 1. The relatively compact nature of the example actuator 28 is feasible only because of the structure of the example power post assembly 12 as will be discussed below.

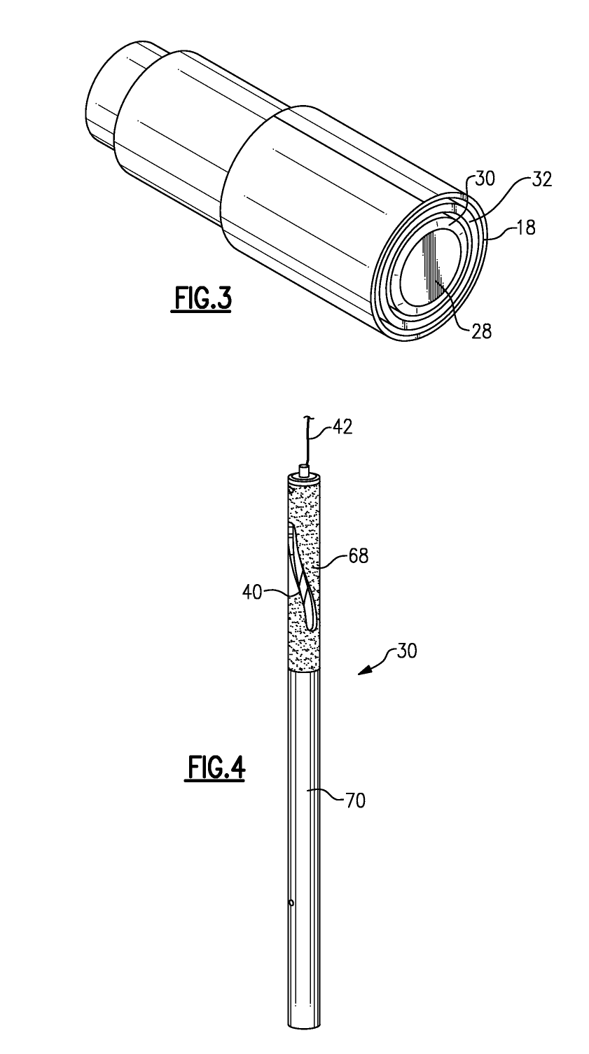

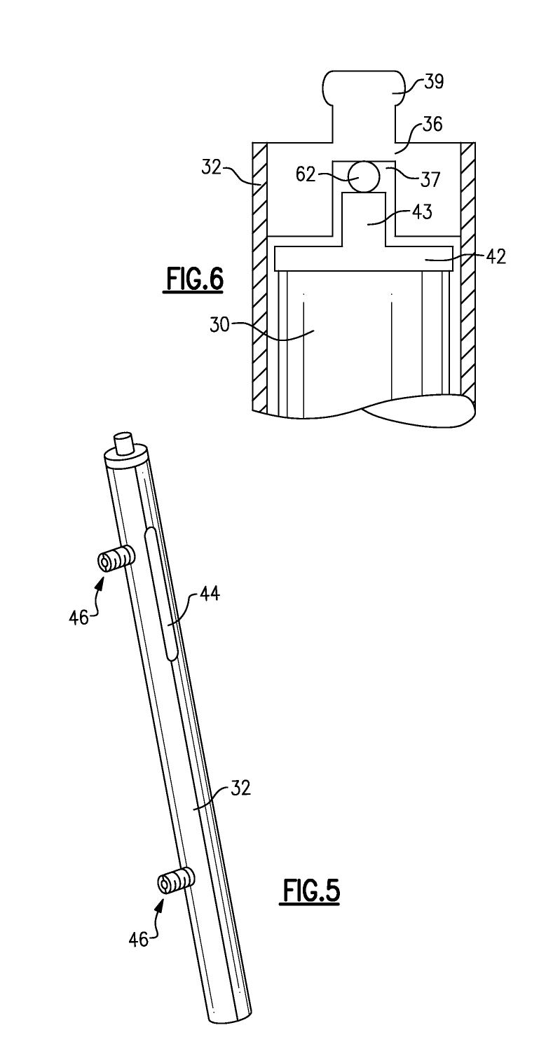

Referring to FIGS. 4, 5 and 6 with continued reference to FIGS. 1, 2A, and 2B, the rotating post 32 is supported on the fixed post 30 through a bearing assembly disposed along the axis 15. The fixed post 30 includes a top cap 42 that supports a single ball bearing 62. The cap 42 includes a support post 43 on which the ball bearing 62 rests. The top guide 36 includes a sleeve or cavity 37 that receives the ball bearing 62 and a portion of the post 43. The weight of the gate assembly 16 and the rotating post 32 are supported at the interface between the single ball bearing 62 and the post 43. The ball bearing 62 substantially reduces frictional forces generated by the weight of the gate assembly 16. Moreover, the bearing 62 is supported along the axis of rotation 15 that further supports the load along the fixed post 30 and the outer tube 18 to reduce forces required to rotate the gate assembly 16. The distribution of load through the bearing 62 to the fixed post 32 results in the ability to utilize motors of reduced size as compared to conventional devices utilized for opening and closing a gate assembly 16.

In this example the fixed post 30 includes a top portion 68 that includes the drive slot 40 and a bottom portion 70 that is separate from the top portion 68. The top portion 68 is then attached to the bottom portion 70 by a welding process. Moreover, other attachment processes could also be utilized to attaché the top and bottom portions 68, 70 of the fixed post 30. The fixed post 30 could also be on single unified part. The separation of parts can simplify machining and fabrication of the drive slot 40. Moreover, different material and wall thickness can also be utilized for the top and bottom portions 68, 70 to facilitate cost savings and further simplify manufacture.

The example cap 42 and top guide 36 include the post 43 supported on the fixed post 30 and the cavity 37 defined within the top guide 36 of the rotating post 32. However, the features could be reversed such that the cap 42 includes the cavity and the top guide includes the post with the single ball bearing 62 disposed there between.

The top guide 36 includes the guide post 39 that is received within the sleeve 35 of the top 22. The guide post 39 includes a semi-spherical shape that accommodates some movement and mis-alignment between the rotating post 32 and the outer tube 18. Moreover, the shape of the guide post 39 along with the ball 37 accommodates relative movement between the rotating post 32 and the outer post 18 while maintaining the desired spacing therebetween.

The fixed post 30 includes a drive slot 40 within which the drive pin 38 guides. The example drive slot 40 is curved to produce rotary motion responsive to vertical movement of the drive pins 38. The rotating post 32 includes the driven channel 44 that is also engaged with the drive pins 38. Vertical movement of the drive pins 38 caused by the actuator 28 produces a rotary motion due to the shape of the drive slot 40. The fixed post 30 does not rotate, but the rotating tube 30 that is also engaged to the drive pins 38 is free to rotate and does due to the support on the ball bearing 62.

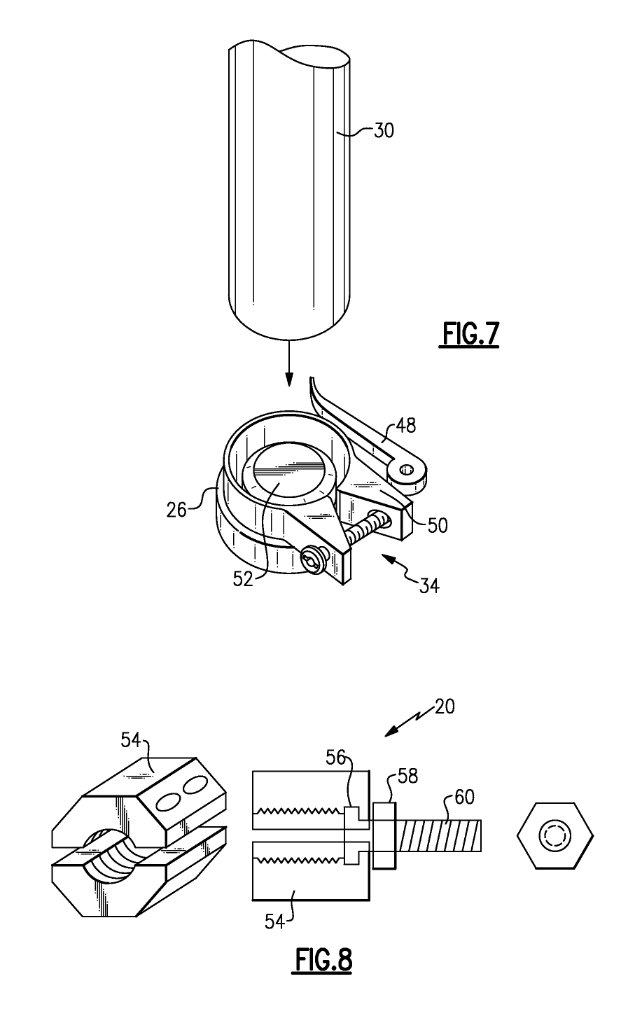

Referring to FIG. 7, with continued reference to FIG. 1, the example clamp assembly 34 includes the base 26 that is mounted within the outer tube 18. The base 26 includes a guide 52 for receiving the fixed post 30. The fixed post 30 is secured to prevent rotation by the clamp 50. The clamp 50 is compressed around the fixed tube 30 by a handle 48. The clamping force applied sufficiently secures the fixed post 30 to maintain a desired alignment and prevent rotation. However, the clamp assembly 34 is not a permanent mounting and provides for rotation of the fixed post 30 in the event that an overwhelming force is encountered. In other words, during normal operation the clamp 34 prevents rotation of the fixed post 30. However, should an overwhelming force be encountered the clamping force provided by the clamp 34 can be overcome and allow rotation of the fixed post 30 to prevent damage to assembly 12. The give provided by the clamp 34 protects the actuator and other parts from damage caused by excessive force on the gate 16.

Referring to FIG. 8, the example fastening assembly 20 includes threaded portion 60 that is received within the gate 16. A hex portion 58 is utilized to tighten the threaded portion 60 into the gate 16. A cap 56 is an integral part of the threaded portion and fits within a clamp 54. The clamp 54 includes internal threads that receive the threaded rods 46 affixed to the rotating post 32. The clamp 54 is rotatable relative to the threaded portion 60 to provide adjustment of a distance between the outer post 18 and the gate 16. Once a desired position is obtained, fasteners such as screws are tightened to compress the clamp 54 around the threaded rod 46 to maintain the desired alignment.

Accordingly, the disclosed example gate assembly 16 includes features that provide for the automatic opening and closing while concealing and protecting the drive mechanism and actuator from the elements or undesired tampering.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A powered post assembly for moving a gate assembly comprising:
an outer post mountable to a fixed support, the outer post defining an internal space and including at least one opening;
a rotating post disposed within the outer post, the outer post including a fastening member extending through the at least one opening, wherein the fastening member provides a connection point for supporting a movable gate assembly;
a fixed post supporting rotation of the rotating post within the outer post; and
an actuator driving the rotating post and the fastening member relative to the fixed post and the outer post.

2. The powered post assembly as recited in claim 1, including a bearing assembly supporting the rotating post on the fixed post, wherein the bearing structure includes a single ball bearing centered along an axis of rotation of the outer post.

3. The powered post assembly as recited in claim 2, including a support supported on one of the fixed post and the rotating post and a sleeve disposed about the support with the single ball bearing disposed between the support and the sleeve.

4. The powered post assembly as recited in claim 1, wherein the fixed post comprises a drive slot and the actuator moves a drive pin within the drive slot, the drive pin extending through the drive slot and into driving contact with the rotating post for moving the rotating post relative to the fixed post within the internal space defined by the outer post.

5. The powered post assembly as recited in claim 4, wherein the rotating post includes a driven slot within which the drive pin guides for rotating the rotating post.

6. The powered post assembly as recited in claim 5, wherein the actuator moves the drive pin linearly within the drive slot, the drive slot including a shape translating linear movement to rotary movement such that linear movement, and the driven slot comprises a straight opening corresponding to the linear movement of the drive pin.

7. The powered post assembly as recited in claim 1, wherein the fastening member comprise at least two fastening members and the at least one opening in the outer post comprises at least two slots through which a corresponding one of the fastening members extends.

8. The powered post assembly as recited in claim 7, wherein the fastening members comprise threaded rods and a mounting bracket is attached to the threaded rod.

9. The powered post assembly as recited in claim 8, wherein the mounting bracket comprises a channel that receives a slider movable within the channel and securable in a desired position along a length of the channel.

10. The powered post assembly as recited in claim 9, including an adaptor attached to the slider for securing the gate assembly, the adaptor adjustable to vary a distance between the gate assembly and the outer post.

11. The powered post assembly as recited in claim 1, including a base plate supported within the outer post for supporting the fixed post, the base plate including an outer shape corresponding to the internal space of the outer post and a clamp for securing the fixed post.

12. A power actuated gate assembly comprising:
an outer post defining an internal space and including at least two horizontal slots for a movable attachment member;
a fixed post supported within the internal space;
a rotating post supported for rotation relative to the fixed post, the attachment member secured to the rotating post;
an actuator disposed within the fixed post for driving rotation of the rotating post relative to the fixed post; and
a bracket secured to the attachment member and disposed outside of the outer post that is adapted to receive a bracket for securing a gate assembly.

13. The power actuated gate assembly as recited in claim 11, including a bearing assembly supporting the rotating post on the fixed post, wherein the bearing structure includes a single ball bearing centered along an axis of rotation of the rotating post.

14. The power actuated gate assembly as recited in claim 11, wherein the fixed post includes a drive slot, the rotating post includes a driven channel, and the actuator drives a drive pin that extends through the driven slot into the drive channel.

15. The power actuated gate assembly as recited in claim 12, wherein the actuator comprises a motor rotating a threaded shaft with a driven member movable linearly along the threaded shaft responsive to rotation of the threaded shaft, the driven member driving the drive pin linearly.

16. The power actuated gate assembly as recited in claim 12, wherein the bracket comprises a channel that extends along a length of the outer post, the bracket movable with the rotating post relative to the outer post and including a channel that receives sliding elements, wherein the sliding elements are securable within the channel.

17. The power actuated gate assembly as recited in claim 16, including a holder for attachment one a first end to the gate assembly and on a second end to the slider disposed within the channel, the holder including an adjustment structure for setting a distance between the gate assembly and the outer post.

18. The power actuated gate assembly as recited in claim 12, including a support base disposed within the outer post for supporting the fixed post, the support base including a clamp for holding the fixed post in a desired position, the clamp releasable for adjusting a rotational position of the fixed post within the outer post.

19. The power actuated gate assembly as recited in claim 12, wherein the gate assembly is movable through an operating range of 180 degrees.
